(19) United States
(12) Patent Application Publication
(10) Pub. No.: US 2013/0035787 A1
(43) Pub. Date: Feb. 7, 2013

(54) QUICK RESPONSE (QR) CODE GENERATION IN VENDING MACHINES OR KIOSKS FOR CUSTOMER ENGAGEMENT

(71) Applicant: James M. Canter, Austin, TX (US)

(72) Inventor: James M. Canter, Austin, TX (US)

(73) Assignee: CRANE MERCHANDISING SYSTEMS, INC., Bridgeton, MO (US)

(21) Appl. No.: 13/565,620

(22) Filed: Aug. 2, 2012

Related U.S. Application Data
(60) Provisional application No. 61/514,351, filed on Aug. 2, 2011.

(51) Int. Cl. G06F 17/00

(52) U.S. Cl. 700/232

(57) ABSTRACT

Deeper customer engagement through a vending machine is provided by display of a quick response (QR) code on a customer interface display for the vending machine during a vend transaction. The customer can scan the displayed QR code with a smart phone camera to link to a website containing an advertisement, providing detailed nutritional information for a product available for vending from the vending machine, allowing collection of loyalty points or enabling reporting of a service issue or entry of a customer review.

### CROSS-REFERENCE TO RELATED APPLICATIONS

This application claims priority to U.S. Provisional Patent Application Ser. No. 61/514,351 entitled QUICK RESPONSE (QR) CODE GENERATION IN VENDING MACHINES OR KIOSKS FOR CUSTOMER ENGAGEMENT and filed on Aug. 2, 2011. The content of the above-identified patent document is incorporated herein by reference.

### TECHNICAL FIELD

The present application relates generally to customer interaction in vending machine transactions and, more specifically, to use of quick response codes for customer interaction during a vending transaction.

### BACKGROUND

Vending machines offer unattended sales of commodities such as snacks, canned or bottled beverages, or any of a variety of other articles. In the past, customer interaction in vending machines has typically involved little more than selection of products, presentation of payment, and receipt of the selected product. Such limited customer interaction has resulted primarily from the simplistic, low-cost user interface devices commonly provided in vending machines. However, customers in virtually every commercial sector increasingly expect rich purchasing transaction experiences and engaging, interactive customer or user interfaces.

There is, therefore, a need in the art for improved customer interfaces in vending machines.

### SUMMARY

Deeper customer engagement through a vending machine is provided by display of a quick response (QR) code on a customer interface display for the vending machine during a vend transaction. The customer can scan the displayed QR code with a smart phone camera to link to a website containing an advertisement, providing detailed nutritional information for a product available for vending from the vending machine, allowing collection of loyalty points or enabling reporting of a service issue or entry of a customer review.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a simplified perspective view illustrating a vending machine implementing QR code generation to alter a vend transaction according to one embodiment of the present disclosure;

FIG. 2 is a block diagram of a control system within a vending machine implementing QR code generation to alter a vend transaction according to one embodiment of the present disclosure;

FIG. 3 is a product or vend transaction related QR code generated for display on a customer interface to alter a vend transaction according to one embodiment of the present disclosure; and

FIGS. 4A through 4D are high level flowcharts for portions of vending processes employing QR code generation to alter a vend transaction according to one embodiment of the present disclosure.

### DETAILED DESCRIPTION

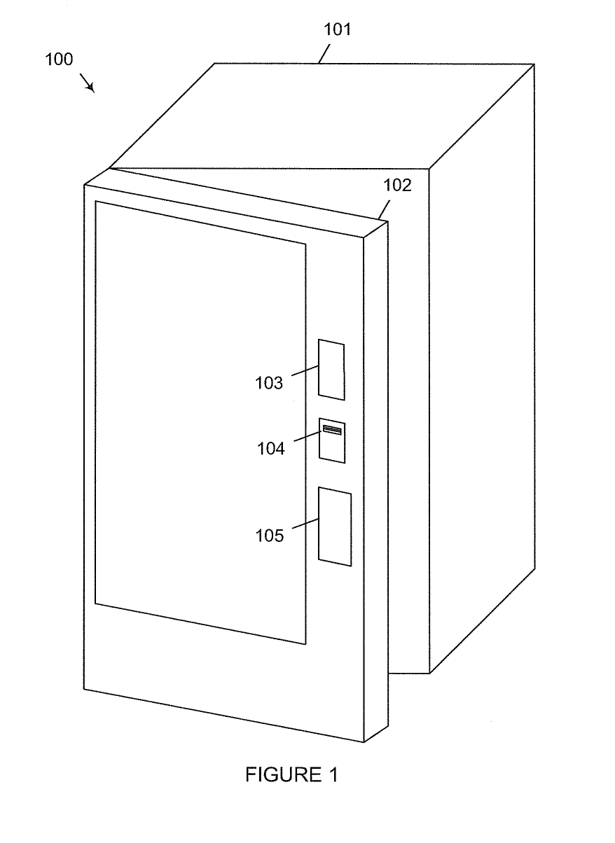

FIGS. 1 through 4D, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged vending machine currency handling system.

The present disclosure relates to generation of quick response (QR) codes in a vending machine customer user interface for use in customer engagement. QR codes are two-dimensional (matrix) barcodes formed by black modules arranged in a square pattern on a white background that are readable by dedicated QR barcode readers and many smart phone cameras and encoding, for example, text, a uniform resource locator (URL), or other data. Smart phone applications (or “apps”) capable of reading QR codes are gaining in popularity.

In the present disclosure, a QR code is displayed on a liquid crystal display (LCD) customer interface screen in a vending machine. The customer uses a QR code-driven smart phone app to scan the displayed QR code via the phone's camera in order to obtain some benefit, such as obtaining a discount on a current purchase, obtaining additional loyalty reward points for the current purchase, accessing more information about a promotion or advertisement including the QR code, accessing product reviews or detailed nutritional information (or the like) for products available for purchase, accessing sponsored entertainment, reporting service issues, or (for service technicians or operators) obtaining information regarding the machine's operational status. By displaying the QR code on a vending machine or kiosk display in order to allow a customer to scan that code using a smart phone camera or similar device, and a vend transaction may be altered based on the customer scanning of the QR code and then taking appropriate action. For example, the customer may be offered a discount if they watch a commercial, establish a loyalty rewards account, etc.

FIG. 1 is a simplified perspective view illustrating a vending machine implementing QR code generation to alter a vend transaction according to one embodiment of the present disclosure. Vending machine 100 includes a cabinet 101 and a service door 102 that, together, define an enclosure. In the exemplary embodiment illustrated, the service door 102 is pivotally mounted to the front of the cabinet 101 and extends all the way across the front face of the vending machine 100. In alternate designs, the service door may extend only part way across the front of the vending machine, or may be formed in two portions (of equal or unequal sizes) that swing open in opposite directions.

In the exemplary embodiment illustrated in FIG. 1, the service door 102 includes a customer user interface 103, illustrated as a touch screen liquid crystal display (LCD) display. A payment system 104 is mounted within the service door 102 and includes one or more of a bill validator, a coin acceptor and/or a credit or debit card reader. The payment system 104 receives currency, coins or other forms of payment from the customer and returns change as necessary. Finally, FIG. 1 depicts an access port 105 to a delivery receptacle mounted within the service door 102 or in the cabinet 101. The access port 105 may have a delivery door or other mechanical system (e.g., rotatable delivery receptacle open on one side) for controlling or restricting access by the customer into the delivery receptacle, the interior of the vending machine, or both. Those skilled in the art will recognize that in some vending machines, particularly helical coil snack vending machines, the access port 105 may be located near the bottom of the vending machine and extend across most of the width of the machine, below a large glass window allowing the contents within the cabinet to be viewed or a large liquid crystal display selectively presenting images of products available for vending or advertisements. Other vending machines, in particular beverage vending machines, have X-Y product retrieval and delivery mechanisms and a glass front or large liquid crystal display, but may include an access port 105 to the side as shown in FIG. 1, at a height convenient to the customer for product retrieval without bending over.

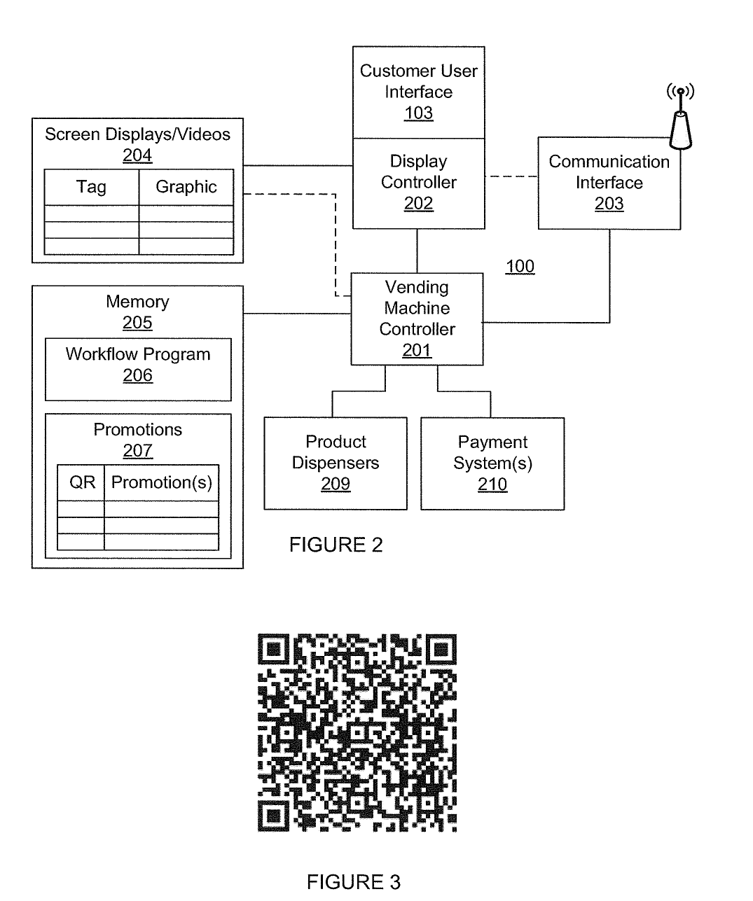

FIG. 2 is a block diagram of a control system within a vending machine implementing QR code generation to alter a vend transaction according to one embodiment of the present disclosure. Vending machine 100 includes a programmable vending machine controller (VMC) 201 of the type known in the art. Coupled to and communicating with VMC 201 is a display controller 202 for the customer user interface 103. The display controller 202 renders content for display on the customer user interface 103 and detects customer contact with the touch screen for the customer user interface 103. Suitable touch-screen display devices and the associated controllers for use as customer user interface 103 and display controller 202 are known in the art.

VMC 201 is also coupled to and communicates with a communication interface 203 enabling data transfer to external devices, such as a handheld computer, a network operations center or another vending machine. Communication may be by wireless data transfer or through an access port (e.g., Universal Serial Bus or “USB”) provided in the vending machine 100, as known in the art. Communication with devices external to the vending machine 100 allows for update of the screen displays and/or videos employed during a vend transaction, for update of the programming of the vending machine 100 or download of operational data such as sales, remaining inventory or the operational status of various subsystems, or for the coordinated and common operation of multiple vending machines.

At least the display controller 202 and optionally also the VMC 201 are coupled to and communicate with a memory 204 containing the screen displays and/or videos rendered on the customer user interface 103 during a vend transaction and between transactions. Screen display graphics and/or videos are stored in memory 204 in exclusive association with a “tag” or unique identifier employed to access the respective content for display on customer user interface 103, as described in further detail below.

Vending machine controller 201 is coupled to or includes another memory 205 used to control a process flow for vend transactions. While depicted as separate from VMC 201, memory 205 may actually be implemented within the same integrated circuit as VMC 201. Memory 205 stores the workflow program 206 used to control the vending machine's operations during a vend transaction, and optionally a table 207 of promotions associated with various QR codes, in addition to the QR codes themselves. In the exemplary embodiment, the promotions are organized by QR code.

Vending machine controller 201 is also coupled to and communicates with one or more product dispensers 209 (e.g., helical coils or an X-Y product retrieval mechanism) and payment systems 210 such as any combination of a coin mechanism, a bill validator or recycler, and a magnetic stripe card reader. VMC 201 receives signals from and/or controls the operation of product dispensers 209 and payment systems 210 during vend transactions.

Those skilled in the art will recognize that the complete structure and operation of a vending machine is not depicted or described herein. Instead, for simplicity and clarity, only so much of the complete structure and operation of a vending machine as is unique to the present disclosure or necessary for an understanding of the present disclosure is depicted and described.

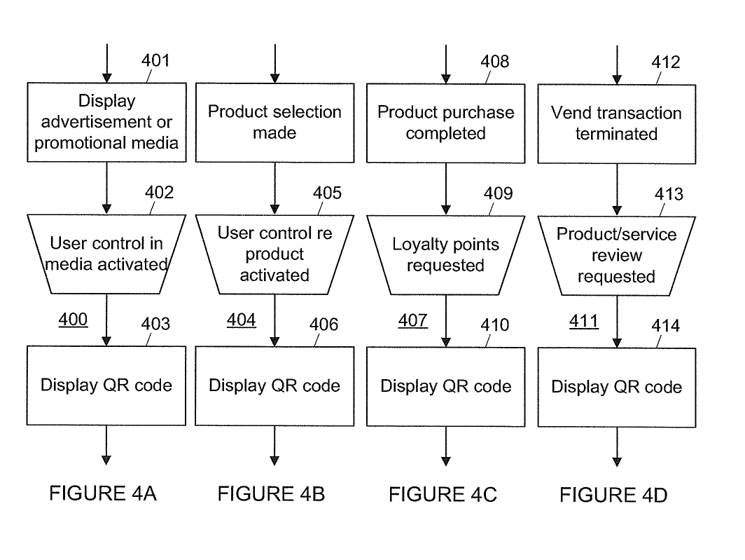

FIG. 3 is a product or vend transaction related QR code generated for display on a customer interface to alter a vend transaction according to one embodiment of the present disclosure. FIGS. 4A through 4D are high level flowcharts for portions of vending processes employing QR code generation to alter a vend transaction according to one embodiment of the present disclosure. Process 400 illustrated in FIG. 4A relates to periods when the vending machine is “idle”—that is, no vend transaction is being processed. An advertisement (for products or services other than those available for purchase from the vending machine) or promotional media (for products or services available within the vending machine) is displayed (step 401) on the customer interface. For example, the advertisement might encourage passersby to view more information about a product or service by activating a user control within the displayed media, or the promotional media might state “Receive double loyalty points” for purchases made during the period of display (e.g., a normally low sales time of day), with a user control being displayed within the media for initiating receipt of such extra loyalty points. Upon a user control being activated (step 402), the vending machine displays a QR code on the customer interface (step 403). Absent actuation of the user control on the displayed media, the QR code would not be displayed.

The customer then scans the QR code from the vending machine customer interface using a smart phone camera and app. The QR code encodes an URL, causing the browser on the customer's smart phone to navigate to a website containing more information about a product or service. The QR code also encodes information (e.g., a vending machine identifier) allowing tracking of a customer by a “referring” source. On-screen promotions and advertisements thus have embedded QR codes provided in the media or media loop to drive the consumer to a mobile-accessible website for more details, in the manner of an Internet “click through.” The vending machine manufacturer and/or the operator then receives click-through compensation for each consumer visiting the website pointed to by the QR code, providing additional potential monetization for either or both of manufacture and operation of the vending machine.

Process 404 illustrated in FIG. 4B relates a portion of a vending transaction either before or after product selection by the customer. A user control regarding nutritional information may be displayed on the customer interface, offering to provide additional nutritional information for a selected product available for vending beyond, for example, the information required on the product label by the Food and Drug Administration (FDA). Upon activation of that user control (step 405), a QR code containing a link to further information on the product manufacturer's website, or to a website listing “points” for the product in a diet plan, is displayed (step 406). Rather than downloading reams of nutritional information to the vending machine, just the most basic information required by law or the most frequently requested information (e.g., caloric content) is maintained at the vending machine. A QR code is then used to drive the consumer to a website for more detailed information. Alternatively, since product portions sizes vary over time (e.g., candy bars become smaller), the QR code may allow the customer to access the current information for a given product and size. The QR code may be used over time, with updates to the linked website made when a new product size is introduced in the vending machine.

Process 407 illustrated in FIG. 4C relates to receipt or collection of customer loyalty points for a purchase. Loyalty programs are increasingly difficult to implement, since customers do not wish to carry around numerous identification media (cards) or provide personal tracking information such as phone numbers or e-mail addresses that may be used as an identifier. Once a product purchase is complete (step 408), if the customer requests loyalty points for the purchase (step 409), a QR code may be displayed on the customer interface (step 410) enabling the customer to collect loyalty points for the purchase. Thus, if a customer purchases a product for $XX, the QR code can take the customer to a website for collecting loyalty points, or an application on the customer's phone can accumulate their loyalty points for later redemption or entry into the system.

The QR code for loyalty points collection may be dynamically generated or selected within the vending machine based on product price and brand for the purchase, so that different numbers of loyalty points may be awarded for different purchases (e.g., no points for popular items versus higher points for purchase of slow-moving items). In addition, points in multiple different loyalty programs may be collected by the customer for a single purchase—for example, the customer may collect both points with the vending machine manufacturer's or operator's loyalty program, as well as points within a brand loyalty program for purchase of a Kraft product versus a MARS product. Additional points may further be collected by a customer due to multi vend transactions (purchase of multiple products by the same customer in a single vend transaction or sequential vend transactions).

Process 411 illustrated in FIG. 4D relates to product or service reviews by a customer. Upon termination of a vend transaction (step 412) for whatever reason, the customer enters a selection button (step 413) requesting a customer review or service report. A QR code is displayed (step 414) to take the customer to a product review website, or to the operator's website to report machine service issues or request a refund of money not refunded by the vending machine.

QR codes may also be generated for service technicians and/or route drivers. For example, information collection at the vending machine from totalizers (total sales counters) can be scanned as a QR code displayed on the customer interface rather than hand entered into a handheld.

The present disclosure describes new techniques for customer interaction at a vending machine, employing QR codes displayed on the customer interface to drive enhanced and deeper communications with the customer. Predefined “static” QR codes (similar to those currently seen on movie posters and in magazine advertisements) may be used in, for example, a promotion, for example. Alternatively, the vending machine may generate “dynamic” QR codes on the fly based, for example, on a number of products purchased in a multi-vend transaction, where the number of loyalty points awarded based on the multi-vend product count (or total amount spent) is generated on dynamically during the vend transaction, and the resulting QR code directs the customer to an URL with the purchase attributes as part of the data (ex: http:www.loyaltyprogram.com?p=marsbar?pr=2.00″).

In connection with the claims below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases may have been provided throughout this patent document, and those of ordinary skill in the art will understand that in many, if not most instances, such definitions apply to prior, as well as future uses of such defined words and phrases.

Although the present disclosure has been described with exemplary embodiments, various changes and modifications may be suggested to one skilled in the art. It is intended that the present disclosure encompass such changes and modifications as fall within the scope of the appended claims.

What is claimed is:

1. A vending machine, comprising:
a vending machine controller;
a customer interface display configured to display content under control of the vending machine controller; and
a memory containing one or more quick response (QR) codes, wherein the vending machine controller causes one of the QR codes to be displayed on the customer interface display in response to an event during a vend transaction.

2. The vending machine of claim 1, wherein the vending machine controller causes one of the QR codes to be displayed on the customer interface display in response to customer activation of a user control within media displayed on the customer interface display.

3. The vending machine of claim 2, wherein the media is one of an advertisement and a product promotion.

4. The vending machine of claim 1, wherein the vending machine controller causes one of the QR codes to be displayed on the customer interface display in response to customer activation of a production selection control.

5. The vending machine of claim 4, wherein the customer activation of a production selection control comprises customer selection of a product during a vend transaction.

6. The vending machine of claim 1, wherein the vending machine controller causes one of the QR codes to be displayed on the customer interface display in response to customer request for loyalty points.

7. The vending machine of claim 6, wherein the customer request for loyalty points is based on purchase of a product.

8. The vending machine of claim 1, wherein the vending machine controller causes one of the QR codes to be displayed on the customer interface display in response to a customer request for a product/service review.

9. The vending machine of claim 8, wherein the customer request for a product/service review is based on termination of a vend transaction.

10. The vending machine of claim 1, wherein the QR codes are readable by a mobile telephone camera.

11. A method of facilitating a vend transaction within a vending machine, comprising:
under control of a vending machine controller, displaying a quick response (QR) code on a customer interface display in response to an event during a vend transaction.

12. The method of claim 11, wherein the QR code is displayed on the customer interface display in response to customer activation of a user control within media displayed on the customer interface display.

13. The method of claim 12, wherein the media is one of an advertisement and a product promotion.

14. The method of claim 11, wherein the QR code is displayed on the customer interface display in response to customer activation of a production selection control.

15. The method of claim 14, wherein the customer activation of a production selection control comprises customer selection of a product during a vend transaction.

16. The method of claim 11, wherein the QR code is displayed on the customer interface display in response to customer request for loyalty points.

17. The method of claim 16, wherein the customer request for loyalty points is based on purchase of a product.

18. The method of claim 11, wherein the QR code is displayed on the customer interface display in response to a customer request for a product/service review.

19. The method of claim 18, wherein the customer request for a product/service review is based on termination of a vend transaction.

20. The method of claim 11, wherein the QR codes are readable by a mobile telephone camera.
